(19) United States
(12) Patent Application Publication
(10) Pub. No.: US 2018/0005051 A1
(43) Pub. Date: Jan. 4, 2018

(54) TRAVEL ROAD SHAPE RECOGNITION APPARATUS AND TRAVEL ROAD SHAPE RECOGNITION METHOD

(71) Applicant: DENSO CORPORATION, Kariya-city (JP)

(72) Inventors: Tomohiko TSURUTA, Nishio-city (JP); Naoki KAWASAKI, Nishio-city (JP); Shunsuke SUZUKI, Kariya-city (JP)

(21) Appl. No.: 15/635,643

(22) Filed: Jun. 28, 2017

(30) Foreign Application Priority Data
Jul. 4, 2016 (JP) 2016-132606

(51) Int. Cl. G06K 9/00; G06T 7/13; G01C 21/36; G06K 9/46

(52) U.S. Cl. CPC G06K 9/00798; G06K 9/4604; G06T 7/13; G01C 21/3602

(57) ABSTRACT

In a travel road shape recognition apparatus, a first travel road shape, which approximates a shape of a road boundary, is calculated based on feature points indicating the travel road boundary in a captured image. A worsening position, which is a position on the calculated first travel road shape at which a degree of coincidence with the feature points worsens, is detected over an area from near to far from an own vehicle. A second travel road shape, which approximates a shape of the road boundary in an area farther from the own vehicle, beyond the worsening position, is calculated. The road boundary in the area nearer to the own vehicle, up to the worsening position, is recognized from the first travel road shape. The road boundary in the area farther from the own vehicle, beyond the worsening position, is recognized from the second travel road shape.

### CROSS-REFERENCE TO RELATED APPLICATION

This application is based on and claims the benefit of priority from Japanese Patent Application No. 2016-132606, filed Jul. 4, 2016. The entire disclosure of the above application is incorporated herein by reference.

### BACKGROUND

### Technical Field

The present disclosure relates to a travel road shape recognition apparatus and a travel road shape recognition method that recognize a shape of a travel road on which a vehicle is traveling.

### Related Art

Conventionally, a travel road shape recognition apparatus that captures an image of an area ahead of an own vehicle in an advancing direction of the own vehicle by an imaging unit, and recognizes a shape and the like of a travel road on which the own vehicle is traveling from the captured image is known.

For example, the travel road shape recognition apparatus detects edge points from the captured image. The edge points indicate a division line (lane marking) such as a white line. The travel road shape recognition apparatus then approximates a line segment connecting the edge points in the vehicle advancing direction, and calculates a shape of a travel road boundary. The travel road shape recognition apparatus then recognizes the travel road based on the calculated travel road shape.

JP-A-2014-186515 discloses a travel road shape recognition apparatus that divides a captured image into a near area and a distant area based on a prescribed distance from the own vehicle, and calculates the shape of the travel road boundary in each area, for the purpose of detecting a division line in the distant area in the captured image.

In cases in which a captured image is unambiguously divided into a near area and a distant area based on a predetermined distance from the own vehicle, and the shape of the travel road boundary is calculated at each position, as in JP-A-2014-186515, the shape of the travel road boundary in the distant area may not be appropriately approximated.

For example, when a sharp curve is present at a far-off distance on the travel road or when, on an S-shaped curve, the shape of the curve differs between a near curve and a distant curve, a distance in the vehicle advancing direction from the own vehicle to a position at which the travel road shape changes varies in time series, based on the position at which the own vehicle is currently traveling. Therefore, when the captured image is unambiguously divided based on the predetermined distance from the own vehicle, the position at which the captured image is divided into the near area and the distant area may significantly deviate from the position at which the shape of the travel road boundary changes. In such cases, the shape of a distant travel road boundary cannot be appropriately approximated. Travel road recognition performance may decrease.

### SUMMARY

It is thus desired to provide a travel road shape recognition apparatus that is capable of improving recognition performance regarding a distant travel road, and a travel road shape recognition method.

An exemplary embodiment provides travel road shape recognition apparatus that includes: an image acquiring unit that acquires a captured image of an area ahead of an own vehicle in an advancing direction of the own vehicle, from an imaging means; a first shape calculating unit that calculates a first travel road shape approximating a shape of a travel road boundary of a travel road on which the own vehicle is traveling based on a plurality of feature points indicating the travel road boundary in the captured image; a position detecting unit that detects a worsening position over an area from near to far from the own vehicle in the captured image, the worsening position being a position on the first travel road shape at which a degree of coincidence with the feature points worsens to be less than an acceptable amount; a second shape calculating unit that calculates a second travel road shape approximating the shape of the travel road boundary in an area farther from the own vehicle, beyond the worsening position, in the captured image, when the worsening position is detected; and a recognizing unit that recognizes the travel road boundary in the area nearer to the won vehicle, up to the worsening position, from the first travel road shape, and the travel road boundary in the area farther from the own vehicle, beyond the worsening position, from the second travel road shape.

When the travel road boundary in a captured image cannot be appropriately approximated, a position at which the degree of coincidence between the feature point of the travel road boundary and the calculated travel road shape decreases appears. Therefore, the first travel road shape is calculated based on the feature points indicating the travel road boundary in the captured image. Then, a worsening position at which the degree of coincidence between the first travel road shape and the feature point worsens is detected over an area from near to far from the own vehicle. When the worsening position is detected, the second travel road shape that is a new travel road shape is calculated for the area farther from the own vehicle, beyond the worsening position. The travel road is recognized from the travel road shape.

As a result of the above-described configuration, the position at which the degree of coincidence between the travel road boundary and the calculated travel road shape worsens is detected from each captured image. Recognition of the travel road boundary in the area beyond this position is performed based on a new travel road shape. Therefore, recognition performance regarding a distant travel road can be improved.

### BRIEF DESCRIPTION OF THE DRAWINGS

In the accompanying drawings:

FIG. 1 is a diagram for explaining a configuration of a vehicle control apparatus according to an embodiment;

FIGS. 2A and 2B are diagrams for explaining difference in a degree of coincidence between a travel road boundary and an approximate curve, attributed to distance from an own vehicle according to the embodiment;

FIG. 3 is a diagram for explaining an approximate curve according to the embodiment;

FIG. 4 is a flowchart for explaining a shape recognition process according to the embodiment;

FIGS. 5A and 5B are diagrams for explaining a degree of coincidence according to the embodiment;

FIGS. 6A and 6B are diagrams for explaining an approximate curve according to the embodiment;

FIGS. 7A and 7B are diagrams for explaining changing of a second approximate curve according to the embodiment; and

FIG. 8 is a graph for explaining an approximate curve determined by using a weighted least squares method according to another embodiment.

### DESCRIPTION OF THE EMBODIMENTS

Embodiments of a travel road shape recognition apparatus and a travel road shape recognition method of the present disclosure will be described with reference to the drawings. Sections that are identical or equivalent to each other among the following embodiments are given the same reference numbers in the drawings. Descriptions of sections having the same reference numbers are applicable therebetween.

### First Embodiment

A travel road shape recognition apparatus according to the present embodiment is configured as a part of a vehicle control apparatus that controls a vehicle. In addition, the vehicle control apparatus uses a travel road shape calculated by the travel road shape recognition apparatus to perform lane keeping assist. In lane keeping assist, the vehicle control apparatus controls an own vehicle such that the own vehicle does not deviate from a division line (lane marking) such as a white line.

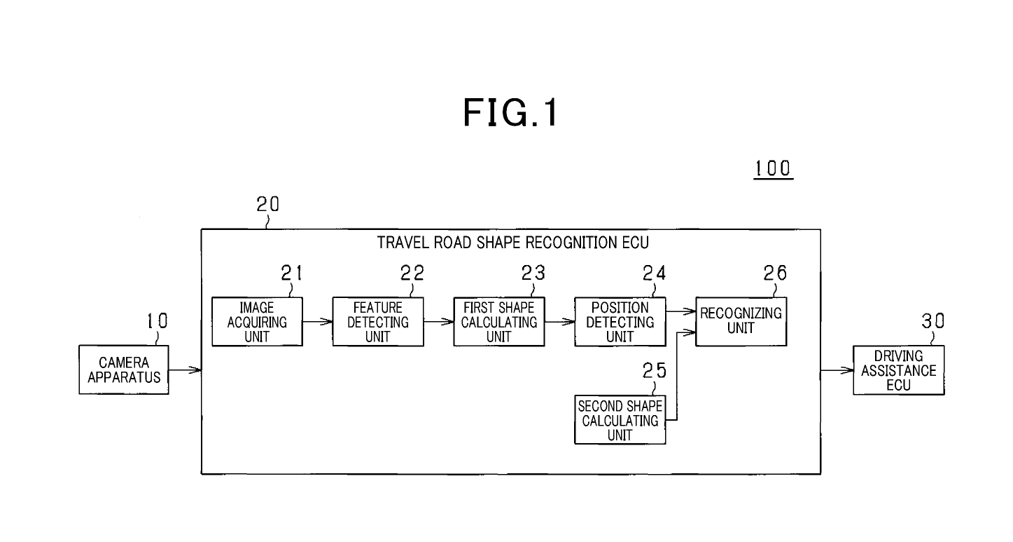

First, a configuration of a vehicle control apparatus 100 according to the present embodiment will be described with reference to FIG. 1. The vehicle control apparatus 100 includes a camera apparatus 10, a travel road shape recognition electronic control unit (ECU) 20, and a driving assistance ECU 30. In FIG. 1, the travel road shape recognition ECU 20 functions as the travel road shape recognition apparatus.

The camera apparatus 10 functions as an imaging means. The camera apparatus 10 captures an image of an area ahead of the own vehicle in the advancing direction of the own vehicle. The camera apparatus 10 is a charge-coupled device (CCD) camera, a complementary metal-oxide-semiconductor (CMOS) image sensor, a near-infrared camera, or the like. The camera apparatus 10 is mounted in the own vehicle in a state in which an imaging direction of the camera apparatus 10 faces the area ahead of the own vehicle. Specifically, the camera apparatus 10 is attached to the center of the own vehicle in a vehicle width direction, such as to a rearview mirror, and captures an image of an area that is spread over a predetermined angular range ahead of the own vehicle.

The travel road shape recognition ECU 20 is configured as a computer that includes a central processing unit (CPU), a read-only memory (ROM), and a random access memory (RAM). The travel road shape recognition ECU 20 functions as an image acquiring unit 21, a feature detecting unit 22, a first shape calculating unit 23, a position detecting unit 24, a second shape calculating unit 25, and a recognizing unit 26 by the CPU running programs stored in a memory.

The travel road shape recognition ECU 20 recognizes a travel road on which the own vehicle is traveling based on the captured image from the camera apparatus 10. In the present embodiment, the travel road shape recognition ECU 20 approximates a shape of a division line with an approximate curve, and recognizes the travel road on which the own vehicle is traveling based on the approximate curve. Here, the division line is an example of a travel road boundary.

The driving assistance ECU 30 controls the own vehicle based on a vehicle speed, a yaw rate, and the like inputted from various types of sensors (not shown), as well as a travel road recognition result from the travel road shape recognition ECU 20. That is, the driving assistance ECU 30 predicts a future position of the own vehicle from the vehicle speed and the yaw rate. The driving assistance ECU 30 then determines whether or not the own vehicle may deviate from the division line using the predicted future position and the travel road recognition result.

For example, in cases in which the driving assistance ECU 30 is provided with a warning function, the driving assistance ECU 30 displays a warning on a display provided in the own vehicle or generates a warning sound from a speaker provided in the own vehicle when determined that the own vehicle may deviate from the division line. In addition, in cases in which the driving assistance ECU 30 is provided with a driving support function, the driving assistance ECU 30 applies steering force to a steering apparatus when determined that the own vehicle may deviate from the division line.

When the travel road shape recognition ECU 20 approximates the shape of the travel road boundary over an area from near to far in the captured image, using the same approximation expression (approximate function), the calculated approximate curve may not match the actual shape of the travel road boundary on the farther side.

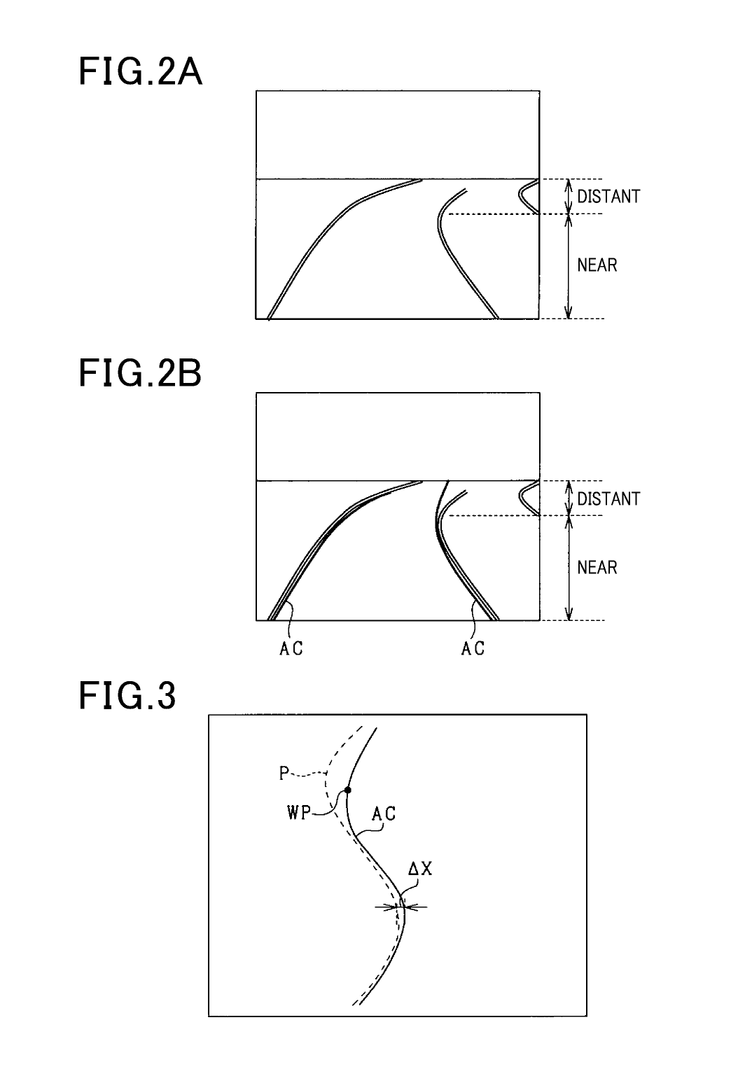

For example, in FIG. 2A, a sharp curve is present on the travel road at a far-off distance, and the shape of the division line near the own vehicle and the shape of the division line far from the own vehicle significantly differ. Therefore, as shown in FIG. 2B, when the shape of the division line is approximated through use of a single approximate curve AC, the approximate curve approximating the distant travel road boundary may significantly deviate from the actual travel road boundary.

In addition, the accuracy of edge point detection changes depending on the traveling environment and the like of the own vehicle. Therefore, it is considered not preferable for a boundary point between the near area and the distant area to be unambiguously prescribed. If the boundary point between the near area and the distant area is too close to the own vehicle, the number of samplings of edge points in the near area decreases. As a result, recognition accuracy in the near area decreases.

In addition, if the boundary point is too far from the own vehicle, the travel road shape in the near area is recognized through use of far-off edge points of which the detection accuracy is low. Therefore, in this case as well, the recognition accuracy in the near area decreases. This may similarly occur on an S-shaped curve, when the curvature of the curve nearer to the own vehicle and the curvature of the curve farther from the own vehicle differ.

Therefore, the travel road shape recognition ECU 20 includes the units shown in FIG. 1 to improve recognition performance regarding a distant travel road. Next, the functions of the units provided in the travel road shape recognition ECU 20 will be described.

Returning to FIG. 1, the image acquiring unit 21 acquires the captured image from the camera apparatus 10. The image acquiring unit 21 stores the captured images captured by the camera apparatus 10 at a predetermined cycle in a memory (not shown).

The feature detecting unit 22 detects a feature point indicating the shape of the division line from the captured image. According to the present embodiment, an edge point P is detected as the feature point. The edge point P indicates an outer shape of the division line in the captured image.

For example, the feature detecting unit 22 uses a known Sobel operator to detect a plurality of edge points P of which the edge strength and edge gradient are equal to or greater than thresholds. Then, the feature detecting unit 22 detects the edge points P positioned in a predetermined search area, among the detected edge points P, as the edge points P of the division line.

The first shape calculating unit 23 calculates a first approximate curve AC1 approximating the shape of the division line based on the edge points P of the division line detected by the feature detecting unit 22. According to the present embodiment, the first approximate curve AC1 is calculated for each of the travel road boundaries on the left and right sides of the travel road in a vehicle lateral direction.

For example, to approximate the shape of the division line, the first shape calculating unit 23 uses a cubic curve approximating a clothoid curve. A reason for this is that a curve segment of a road successively transitions from a transition segment defined by a clothoid curve of which a rate of increase in curvature is fixed, to a segment of which the curvature is fixed, to a transition segment defined by a clothoid curve of which a rate of decrease in curvature is fixed. Therefore, according to the present embodiment, the first approximate curve AC1 is calculated as an example of a first travel road shape.

The first shape calculating unit 23 approximates the shape of the division line using the first approximate curve AC1 which is expressed by an approximate function (e.g., a cubic function in the present embodiment) in an X-Y coordinate system as shown in an expression (1) below.

f(Y)=a1Ŷ3+b1Ŷ2+c1Y+d1 (1)

Here, (̂) indicates an exponent.

In the expression (1), Y denotes a coordinate in the advancing direction (Y-axis direction) of the own vehicle and f(Y) denotes a coordinate in a direction (X-axis direction) perpendicularly intersecting the advancing direction of the own vehicle. In addition, a1, b1, c1, and d1 are coefficients. For example, the first shape calculating unit 23 calculates the coefficients a1, b1, c1, and d1 of an approximate curve of which the distance between the approximate curve and the edge points P is the shortest, using a known least squares method.

The position detecting unit 24 detects a worsening position WP over an area from near to far from the own vehicle in the captured image. The worsening position WP is a position at which a degree of coincidence between the first approximate curve AC1 calculated by the first shape calculating unit 23 and the edge point P of the division line worsens. The degree of coincidence is an index value indicating an amount of deviation between the first approximate curve AC1 and the edge points P of the division line.

According to the present embodiment, the edge points P are positioned closer to the approximate curve AC in the captured image as the value of the degree of coincidence increases. In addition, the edge points P are positioned farther from the approximate curve AC in the captured image as the value of the degree of coincidence decreases. Furthermore, according to the present embodiment, when the degree of coincidence is calculated from an image over an area from near to far from the own vehicle, the worsening position WP is the first position at which the degree of coincidence becomes equal to or lower than a threshold Th (corresponding to an acceptable amount).

In FIG. 3, the approximate curve AC in the near area appropriately approximates the shape of the division line. When the edge points P indicating the division line are superimposed onto the approximate curve AC, a deviation amount ΔX between the positions of the edge points P and the approximate curve AC is small.

Meanwhile, the approximate curve AC in the distant area does not appropriately approximate the shape of the division line. The deviation amount ΔX of the approximate curve AC from the edge points P in the vehicle lateral direction (X-axis direction) is large. Therefore, the deviation amount ΔX between the approximate curve AC and the edge points P of the division line in the vehicle lateral direction can be calculated as the degree of coincidence. The worsening position WP can be detected based on the degree of coincidence.

When the position detecting unit 24 detects the worsening position WP, the second shape calculating unit 25 calculates a second approximate curve AC2. The second approximate curve AC2 approximates the shape of the division line in the area farther from the own vehicle, beyond the worsening position WP, in the captured image.

Specifically, the second shape calculating unit 25 calculates the second approximate curve AC2 based on the edge points P of the division line in the area farther from the own vehicle, beyond the worsening position WP. The second approximate curve AC2 is a curve of which coefficients (a2, b2, c2, and d2) differ from the coefficients (a1, b1, c1, and d1) of the first approximate curve AC1, which is expressed by an approximate function (e.g., a cubic function in the present embodiment) in the X-Y coordinate system as shown in an expression (2) below.

f(Y)=a2Ŷ3+b2Ŷ2+c2Y+d2 (2)

Here, (̂) indicates an exponent.

In the expression (2), Y denotes a coordinate in the advancing direction (Y-axis direction) of the own vehicle and f(Y) denotes a coordinate in a direction (X-axis direction) perpendicularly intersecting the advancing direction of the own vehicle. In addition, a2, b2, c2, and d2 are coefficients. For example, the second shape calculating unit 25 calculates the coefficients a2, b2, c2, and d2 of the second approximate curve AC2 of which the distance between the approximate curve and the edge points P is the shortest, using a known least squares method.

The recognizing unit 26 recognizes the division line in the area nearer to the own vehicle, up to the worsening position WP, from the first approximate curve AC1. The recognizing unit 26 also recognizes the division line in the area farther from the own vehicle, beyond the worsening position WP, from the second approximate curve AC2. For example, the recognizing unit 26 recognizes the travel road by calculating the curvature and the width of the travel road based on the approximate curves AC1 and AC2.

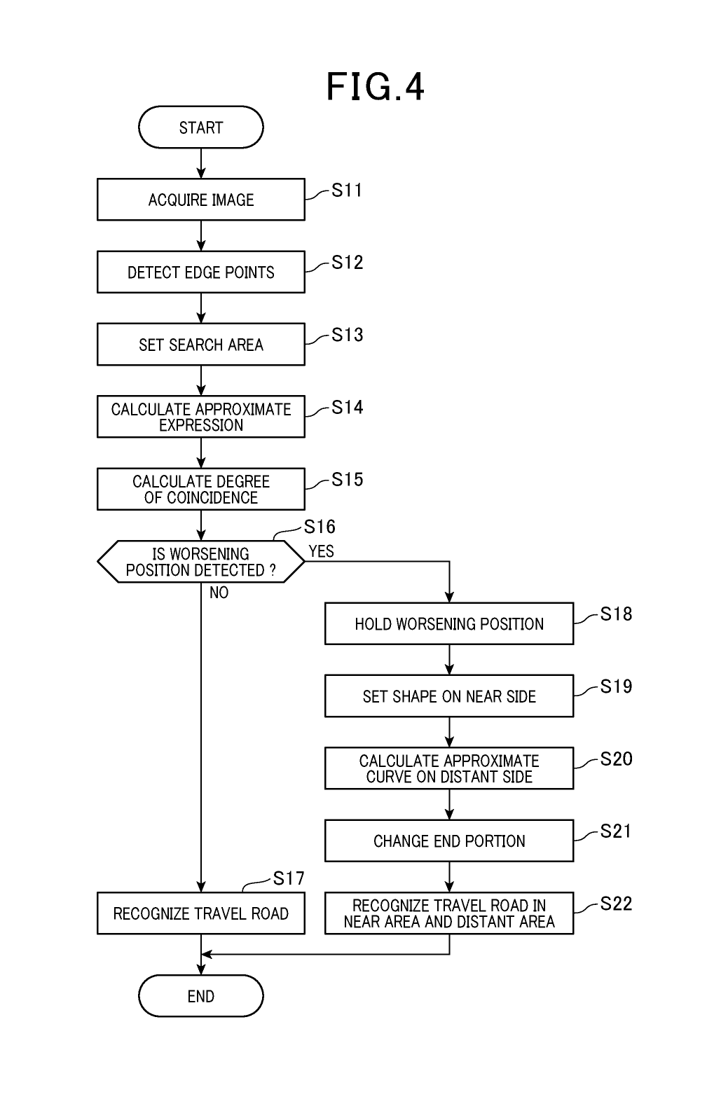

Next, a travel road recognition process performed by the travel road shape recognition ECU 20 will be described with reference to the flowchart in FIG. 4. The series of processes shown in FIG. 4 are performed by the travel road shape recognition ECU 20 at a predetermined cycle. Hereafter, after the series of processes shown in FIG. 4 are performed, the series of processes shown in FIG. 4 that has been performed in the preceding cycle is referred to as a previous series of processes, and thereby differentiated from a current series of processes.

At step S11, the travel road shape recognition ECU 20 acquires a captured image from the camera apparatus 10. The captured image is assumed to include the division line of the travel road on which the own vehicle is traveling. Step S11 functions as an image acquiring step.

At step S12, the travel road shape recognition ECU 20 detects the edge points P in the captured image. The travel road shape recognition ECU 20 detects pixels that generate concentration gradients of a predetermined strength in the captured image as the edge points P.

At step S13, the travel road shape recognition ECU 20 sets a search area for retrieving the edge points P corresponding to the division line, among the edge points P detected at step S12. The search area is set as a fixed area that extends over an area from near to far from the own vehicle in the captured image. When the first approximate curve AC1 has been calculated in the previous series of processes, the travel road shape recognition ECU 20 sets the search area based on the shape of the first approximate curve AC1.

Here, when the number of edge points P included in the search area that has been set is equal to or less than a threshold, the search area may be changed. When the current series of processes is the first series of processes performed to recognize the travel road, the edge points P are retrieved through use of a search area having an initial shape. Step S13 functions as a search area setting unit.

At step S14, the travel road shape recognition ECU 20 calculates the first approximate curve AC1 approximating the shape of the division line, by approximating the edge points P included in the search area set at step S13. For example, the travel road shape recognition ECU 20 calculates the first approximate curve AC1 using a known least squares method on the plurality of edge points P included in the search area.

Here, the travel road shape recognition ECU 20 may calculate the first approximate curve AC1 after performing coordinate conversion of the edge points P onto a planar view using the attachment position and the attachment angle of the camera apparatus 10. Step S14 functions as a first shape calculating step.

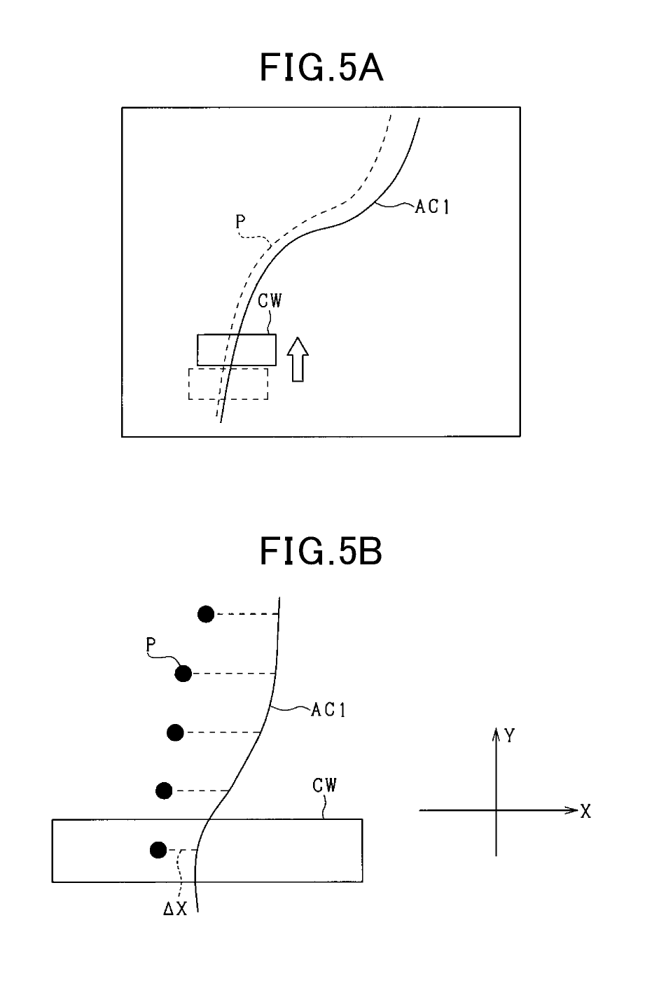

At step S15, the travel road shape recognition ECU 20 calculates the degree of coincidence of the first approximate curve AC1 calculated at step S14 with each edge point P. The travel road shape recognition ECU 20 calculates the degree of coincidence at every predetermined distance (pixels) from the area near the own vehicle in the vehicle advancing direction (Y-axis direction). For example, in FIG. 5A, the travel road shape recognition ECU 20 sets a rectangular calculation area CW in the captured image. The travel road shape recognition ECU 20 then calculates the degree of coincidence between a value on the first approximate curve AC1 included in the calculation area CW and the edge point P of the division line. Step S15 functions as a position detecting step. For example, the length of the calculation area CW in the Y-axis direction is set based on the interval (number of pixels) between the detected edge points P of the division line in the Y-axis direction.

As shown in FIG. 5B, the travel road shape recognition ECU 20 extracts the edge point P of the division line belonging in the calculation area CW. Next, the travel road shape recognition ECU 20 acquires a value of f(Y) of the first approximate curve AC1 that is positioned on the Y-axis of the edge point P in the captured image.

The travel road shape recognition ECU 20 then calculates the deviation amount ΔX between the value of f(Y) and the edge point P of the division line in the lateral direction as the degree of coincidence. In addition, the travel road shape recognition ECU 20 successively calculates the degree of coincidence of the first approximate curve AC1, while changing the position of the calculation area CW towards the side farther from the own vehicle in the Y-axis direction.

In FIG. 5B, only a single edge point P is shown in the single calculation area CW. However, when a plurality of edge points P of the division line is detected in the calculation area CW, the degree of coincidence may be calculated for each edge point P. An average value of the degrees of coincidence may then be calculated.

When the worsening position P at which the degree of coincidence is equal to or less than a predetermined value is not detected on the first approximate curve AC1 (NO at step S16), the travel road shape recognition ECU 20 proceeds to step S17. The worsening position WP is the first position on the first approximate curve AC1 at which the degree of coincidence calculated at step S15 becomes equal to or less than the threshold Th.

At step S17, the travel road shape recognition ECU 20 recognizes the travel road in the captured image based on the first approximate curve AC1 calculated at step S14. In this case, the first approximate curve AC1 appropriately approximates the division line. The shape of the travel road from the near area to the distant area in the captured image is recognized from the first approximate curve AC1.

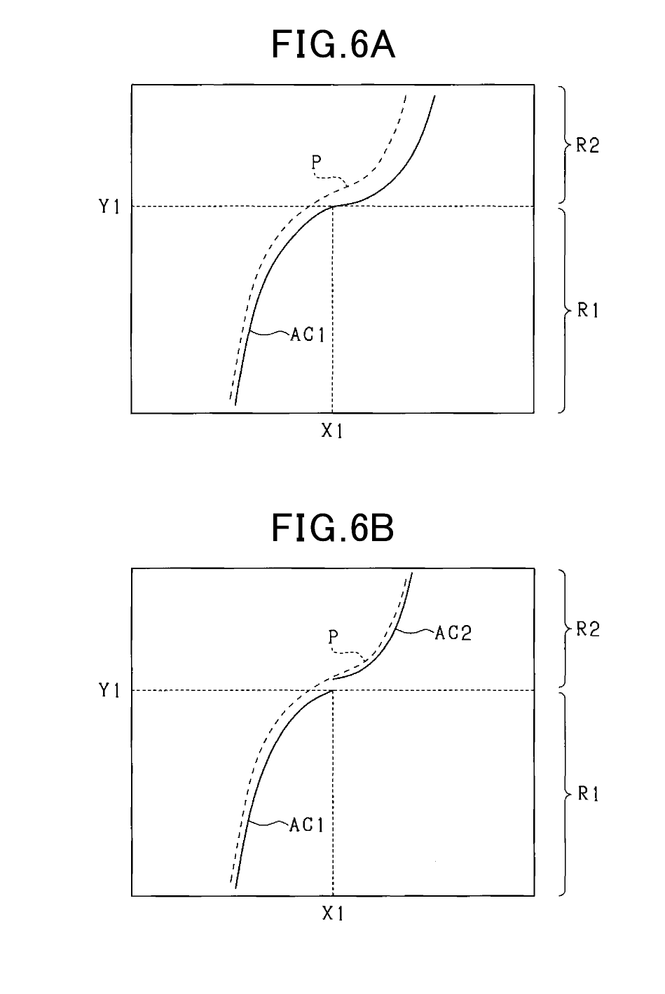

Meanwhile, when determined that the worsening position WP at which the degree of coincidence becomes equal to or less than the threshold Th is detected (YES at step S16), at step S18, the travel road shape recognition ECU 20 holds the coordinates of the worsening position WP in the captured image. For example, in FIG. 6A, the worsening position WP is detected at the coordinates (X1,Y1) in the captured image. Therefore, the travel road shape recognition ECU 20 holds the coordinates (X1,Y1).

At step S19, the travel road shape recognition ECU 20 sets the shape of the division line in the area nearer to the own vehicle, up to the worsening position WP, to the first approximate curve AC1 calculated at step S14.

At step S20, the travel road shape recognition ECU 20 calculates the second approximate curve AC2 based on the edge points P in the area farther from the own vehicle, beyond the worsening position WP. For example, the travel road shape recognition ECU 20 calculates the second approximate curve AC2 using a known least squares method on the edge points P included in the search area set at step S13. In FIG. 6B, the second approximate curve AC2 is calculated for the edge points that are beyond the worsening position WP (X1,Y1) in the captured image. Step S20 functions as a second shape calculating step.

In addition, when the first approximate curve AC1 of a near area R1 and the second approximate curve AC2 of a distant area R2 are separately determined, the occurrence of a misalignment in the vehicle lateral direction at the junction between the first approximate curve AC1 and the second approximate curve AC2 can be considered. Therefore, at step S21, the travel road shape recognition ECU 20 changes the second approximate curve AC2 such as to move the end of the second approximate curve AC2 on the side nearer to the own vehicle closer to the first approximate curve AC1 in the vehicle lateral direction.

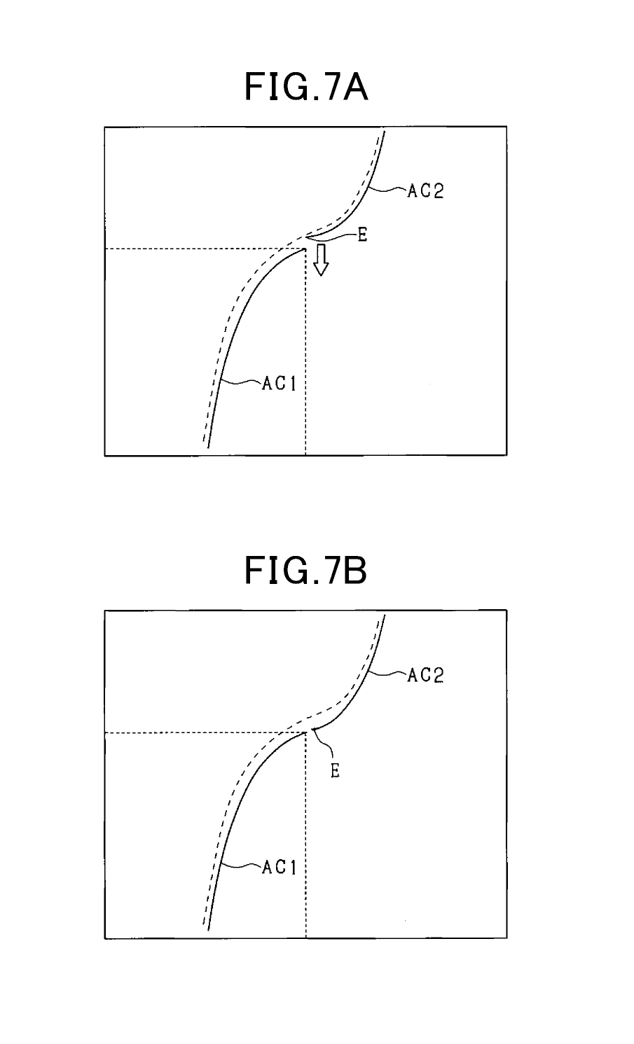

When an end portion E of the second approximate curve AC2 is significantly misaligned in the vehicle lateral direction (X-axis direction) from the first approximate curve AC1 set at step S19, as shown in FIG. 7A, the coefficients (a2, b2, c2, and d2) of the second approximate curve AC2 are changed such that the end portion E of the second approximate curve AC2 is moved closer towards the first approximate curve AC1, as shown in FIG. 7B. Therefore, step S21 functions as a position changing unit.

As a method for moving the end of the second approximate curve AC2 closer to the first approximate curve AC1 at step S21, the gradient (slope) of the curve on the side nearer to the own vehicle including the end portion E may be changed to become closer to the gradient of the curve at the end of the first approximate curve AC1 on the side farther from the own vehicle. In this case as well, for example, the gradient of the curve is changed by the coefficients (a2, b2, c2, and d2) of the second approximate curve AC2 being changed. Therefore, step S21 functions as a curve gradient changing unit.

At step S22, the travel road shape recognition ECU 20 recognizes the shape of the division line in the area nearer to the own vehicle, up to the worsening position WP, from the first approximate curve AC1. The travel road shape recognition ECU 20 also recognizes the shape of the division line in the area farther from the own vehicle, beyond the worsening position WP, from the second approximate curve AC2.

For example, the travel road shape recognition ECU 20 calculates the curvature and the width of the travel road in the area nearer to the own vehicle, up to the worsening position WP, in the captured image, based on the first approximate curve AC1. The travel road shape recognition ECU 20 also calculates the curvature and the width of the travel road in the area farther from the own vehicle, beyond the worsening position WP, in the captured image, based on the second approximate curve AC2. The travel road shape recognition ECU 20 thereby recognizes the travel road. Step S22 functions as a recognizing step. Subsequently, the travel road shape recognition ECU 20 temporarily ends the series of processes in FIG. 4.

As described above, according to the first embodiment, the travel road shape recognition ECU 20 calculates the first approximate curve AC1 based on the edge points P indicating the travel road boundary in a captured image. The travel road shape recognition ECU 20 then detects the worsening position WP on the first approximate curve AC1, over an area from near to far from the own vehicle. The worsening position WP is the position at which the degree of coincidence of the first approximate curve AC1 with the edge point indicating the division line worsen.

Then, when the worsening position WP is detected, the travel road shape recognition ECU 20 calculates a new second approximate curve AC2 for the area farther from the own vehicle, beyond the worsening position WP. The travel road shape recognition ECU 20 performs differing travel road recognition for the area up to the worsening position WP and the area beyond the worsening position WP. As a result of the above-described configuration, because the approximate curve for the area farther from the own vehicle, beyond the position at which the shape of the division line cannot be appropriately approximated, is newly calculated, recognition performance regarding a distant travel road can be improved.

The travel road shape recognition ECU 20 detects the worsening position WP by using the deviation amount in the vehicle lateral direction between the first approximate curve AC1 and the edge point P as the degree of coincidence. At the position at which the degree of coincidence between the approximate curve and the division line worsens, the deviation amount in the vehicle lateral direction between the first approximate curve AC1 and the edge point P of the division line differs by a large amount from the calculated deviation amount for the preceding edge point P. Therefore, the worsening position WP is detected based on the deviation amounts in the vehicle lateral direction between the edge points P of the division line and the first approximate curve AC1. As a result of the above-described configuration, the worsening position WP can be appropriately detected.

The travel road shape recognition ECU 20 acquires the captured images at a predetermined cycle. The travel road shape recognition ECU 20 sets the search area for retrieving the edge points P used to calculate the first approximate curve AC1 in the captured image that is subsequently acquired, based on the first approximate curve AC1 calculated in the captured image that is currently acquired. As a result of the above-described configuration, the amount of time required to calculate the first approximate curve AC1 can be shortened.

When the approximate curve used for recognition in the area beyond the worsening position WP is changed from that used in the area up to the worsening position WP, the travel road recognized in the area up to the worsening position WP and the travel road recognized in the area beyond the worsening position WP may significantly differ in appearance. Therefore, the travel road shape recognition ECU 20 changes the end of the second approximate curve AC2 on the side nearer to the own vehicle such as to become closer to the first approximate curve AC1.

Alternatively, the travel road shape recognition ECU 20 changes the gradient of the curve at the end of the second approximate curve AC2 on the side nearer to the own vehicle such as to become closer to the gradient of the curve at the end of the first approximate curve AC1 on the side farther from the own vehicle. As a result of the above-described configuration, for example, even when the recognized travel road is to be displayed in a display unit, significant difference in appearance between the boundary shape approximated in the area up to the worsening position WP and the boundary shape approximated beyond the worsening position WP can be suppressed.

### Other Embodiments

A wall on the side of a road or a guardrail may be used as the travel road boundary, instead of the division line. In this case, at step S13 in FIG. 4, the travel road shape recognition ECU 20 sets the search area based on the shape of the object being detected as the travel road boundary and retrieves the edge points P for calculating the approximate curve AC.

Use of the cubic curve as the approximate curve for approximating the travel road boundary is merely an example. A quartic curve or a circular arc may also be used.

Two or more approximate curves AC for approximating the travel road boundary may be produced. In this case, when the degree of coincidence is calculated over an area from near to far from the own vehicle in the captured image, and a plurality of worsening positions WP at which the degree of coincidence becomes equal to or greater than a threshold is detected at step S16 in FIG. 4, first, the second approximate curve AC is calculated for the travel road boundary segmented by the worsening positions WP. Then, a third approximate curve AC3 is calculated for the travel road boundary beyond the worsening position WP that is farther from the vehicle.

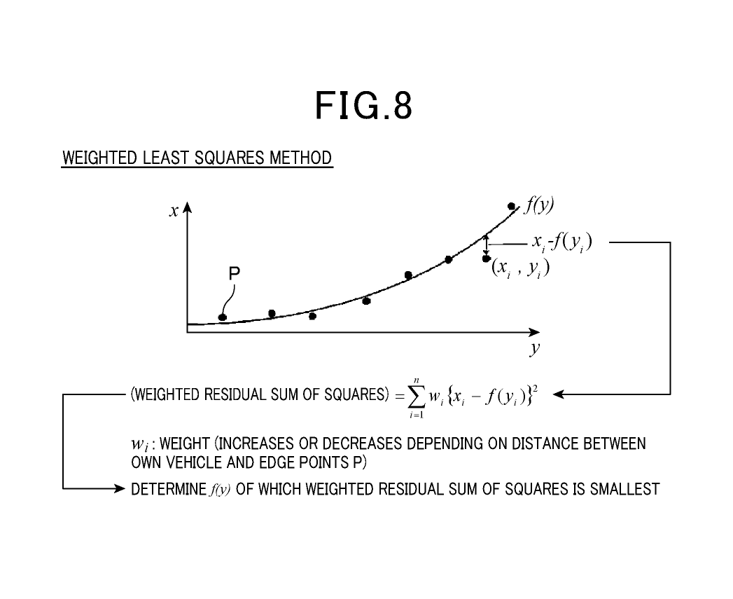

In the present embodiment, the first approximate curve AC1 is determined by using a known least squares method such that the first approximate curve AC1 in the near area more appropriately approximates the shape of the division line, compared with the first approximate curve AC1 in the distant area. For example, the first approximate curve AC1 may be determined by using a weighted least squares method shown in FIG. 8.

In FIG. 8, an approximate curve is expressed by f(y) in the x-y coordinate system, which corresponds to f(Y) in the X-Y coordinate system as described above, where y is a coordinate in the advancing direction (y-axis direction) of the own vehicle and f(y) is a coordinate in a direction (x-axis direction) perpendicularly intersecting the advancing direction of the own vehicle. The approximate curve expressed by f(y) in the x-y coordinate system is determined by using the weighted least squares method, based on coordinates (x₁, y₁), (x₂, y₂), . . . , (xᵢ, yᵢ), . . . , (xₙ, yₙ) (n is a natural number) of the edge points P in the x-y coordinate system and predetermined weights w₁, w₂, . . . , wᵢ, . . . , wₙ for coordinates (x₁, y₁), (x₂, y₂), . . . , (xᵢ, yᵢ), . . . , (xₙ, yₙ) of the edge points P. In this case, a weighted residual sum of squares is expressed by:

$$weighted residual sum of squares = {\sum }_{i = 1}^{n} {w}_{i} {\{ {x}_{i} - f ( {y}_{i} ) \}}^{2}$$

As the approximate curve, f(y) of which the weighted residual sum of squares is smallest is obtained. Here, the weights for coordinates of the edge points P may be set to increase or decrease depending on a distance between the own vehicle and the edge points P or the like.

For example, in FIG. 3, the weights for coordinates of the edge points P in an area (near area) near to the own vehicle may be set to be larger than the weights for coordinates of the edge points P in an area (distant area) far from the own vehicle. Instead of this, the weights for coordinates of the edge points P may be set to increase as the distance between the own vehicle and the edge points P decreases (i.e., as the edge points P become nearer to the own vehicle). Thus, the first approximate curve AC1 in the near area more appropriately approximates the shape of the division line, compared with the first approximate curve AC1 in the distant area.

A method for estimating an approximate curve such as a cubic curve is not limited to a known method of least squares (e.g., weighted least squares method) as described above. For example, a known method using a Kalman filter or the like may be used to estimate an approximate curve such as a cubic curve.

What is claimed is:

1. A travel road shape recognition apparatus comprising:
an image acquiring unit that acquires a captured image of an area ahead of an own vehicle in an advancing direction of the own vehicle, from an imaging means;
a first shape calculating unit that calculates a first travel road shape approximating a shape of a travel road boundary based on a plurality of feature points indicating the travel road boundary in the captured image;
a position detecting unit that detects a worsening position over an area from near to far from the own vehicle in the captured image, the worsening position being a position on the first travel road shape at which a degree of coincidence with the feature points worsens;
a second shape calculating unit that calculates a second travel road shape approximating the shape of the travel road boundary in an area farther from the own vehicle, beyond the worsening position, in the captured image, when the worsening position is detected; and
a recognizing unit that recognizes the travel road boundary in the area nearer to the own vehicle, up to the worsening position, from the first travel road shape, and the travel road boundary in the area farther from the own vehicle, beyond the worsening position, from the second travel road shape.

2. The travel road shape recognition apparatus according to claim 1, wherein:
the position detecting unit detects the worsening position using a deviation amount in a vehicle lateral direction between the first travel road shape and the feature points as the degree of coincidence.

3. The travel road shape recognition apparatus according to claim 2, wherein:
the image acquiring unit acquires the captured images at a predetermined cycle; and
the travel road shape recognition apparatus further comprises
a search area setting unit that sets a search area for retrieving the feature points used to calculate the first travel road shape in the captured image that is subsequently acquired, based on the first travel road shape calculated in the captured image that is currently acquired.

4. The travel road shape recognition apparatus according to claim 3, further comprising:
a position changing unit that changes a position of an end of the second travel road shape on a side nearer to the own vehicle that has been calculated by the second shape calculating unit to become closer to the first travel road shape.

5. The travel road shape recognition apparatus according to claim 3, further comprising:
a curve gradient changing unit that changes a gradient of a curve at an end of the second travel road shape on a side nearer to the own vehicle that has been calculated by the second shape calculating unit to become closer to a gradient of a curve at an end of the first travel road shape on a side farther from the own vehicle.

6. The travel road shape recognition apparatus according to claim 1, wherein:
the image acquiring unit acquires the captured images at a predetermined cycle; and
the travel road shape recognition apparatus further comprises
a search area setting unit that sets a search area for retrieving the feature points used to calculate the first travel road shape in the captured image that is subsequently acquired, based on the first travel road shape calculated in the captured image that is currently acquired.

7. The travel road shape recognition apparatus according to claim 1, further comprising:
a position changing unit that changes a position of an end of the second travel road shape on a side nearer to the own vehicle that has been calculated by the second shape calculating unit to become closer to the first travel road shape.

8. The travel road shape recognition apparatus according to claim 2, further comprising:
a position changing unit that changes a position of an end of the second travel road shape on a side nearer to the own vehicle that has been calculated by the second shape calculating unit to become closer to the first travel road shape.

9. The travel road shape recognition apparatus according to claim 1, further comprising:
a curve gradient changing unit that changes a gradient of a curve at an end of the second travel road shape on a side nearer to the own vehicle that has been calculated by the second shape calculating unit to become closer to a gradient of a curve at an end of the first travel road shape on a side farther from the own vehicle.

10. The travel road shape recognition apparatus according to claim 2, further comprising:
a curve gradient changing unit that changes a gradient of a curve at an end of the second travel road shape on a side nearer to the own vehicle that has been calculated by the second shape calculating unit to become closer to a gradient of a curve at an end of the first travel road shape on a side farther from the own vehicle.

11. The travel road shape recognition apparatus according to claim 1, wherein:
the first shape calculating unit calculates, as the first travel road shape, a first approximate curve using a least squares method, the first approximate curve being a curve expressed by an approximate function having first coefficients; and
the second shape calculating unit calculates, the second travel road shape, a second approximate curve using a least squares method, the second approximate curve being a curve expressed by an approximate function having second coefficients that differ from the first coefficients.

12. The travel road shape recognition apparatus according to claim 11, wherein:
the least squares method used in the first shape calculating unit is a weighted least squares method using a predetermined weight for each feature points, the predetermined weight being set to increase or decrease depending on a distance between the own vehicle and each feature points.

13. A travel road shape recognition method comprising:
an image acquiring step of acquiring a captured image of an area ahead of an own vehicle in an advancing direction of the own vehicle, from an imaging means;
a first shape calculating step of calculating a first travel road shape approximating a shape of a travel road boundary of a travel road on which the own vehicle is traveling based on a plurality of feature points indicating the travel road boundary in the captured image;
a position detecting step of detecting a worsening position over an area from near to far from the own vehicle in the captured image, the worsening position being a position on the first travel road shape at which a degree of coincidence with the feature points worsens;
a second shape calculating step of calculating a second travel road shape approximating the shape of the travel road boundary in an area farther from the own vehicle, beyond the worsening position, in the captured image, when the worsening position is detected; and
a recognizing step of recognizing the travel road boundary in the area nearer to the own vehicle, up to the worsening position, from the first travel road shape, and the travel road boundary in the area farther from the own vehicle, beyond the worsening position, from the second travel road shape.
